(19) United States
(12) Patent Application Publication
(10) Pub. No.: US 2022/0017369 A1
(43) Pub. Date: Jan. 20, 2022

(54) DISPERSANT FOR CARBON NANOTUBES OR NANOSTRUCTURES

(71) Applicant: Halliburton Energy Services, Inc., Houston, TX (US)

(72) Inventor: George Robert Anderson, Houston, TX (US)

(21) Appl. No.: 17/358,863

(22) Filed: Jun. 25, 2021

Related U.S. Application Data
(60) Provisional application No. 63/053,327, filed on Jul. 17, 2020.

(51) Int. Cl. C01B 32/174

(52) U.S. Cl. CPC C01B 32/174

(57) ABSTRACT

Compositions and methods for the use of dispersants for carbon nanotube or carbon nanostructure dispersions are provided. In some embodiments the present disclosure provides a composition including a non-aqueous fluid; a carbon nanostructure; a dispersant selected from the group consisting: of a high molecular weight nonylphenol resin, a medium molecular weight nonylphenol resin, a low molecular weight nonylphenol resin, an ethoxylated nonylphenol resins, polyisobutylene succinic anhydride, a calcium overbased sulfonate, N-methyl-2-pyrrolidone (NMP), imidazoline, a derivative of the foregoing, and any combination thereof; and a solvent.

### BACKGROUND

The present disclosure relates to compositions and methods for the use of dispersants for carbon nanotube or carbon nanostructure dispersions.

Carbon black may be mixed with many different materials to improve the properties of end use applications. For example, carbon black may be used as a rubber-reinforcing filler in tires and various industrial rubber products, as well as a colorant for printing inks, paints, coatings, etc. Since the surface of carbon black largely includes graphitic crystallites, it has a certain inherent degree of electrical conductivity and thus is also used as a filler for the purpose of imparting electrostatic properties to plastics, paints, and other non-conductive materials. In order to gain acceptable electrical conductivity without high loadings (and higher stiffness), carbon black may be chemically oxidized such that only a hollow “shell” of the graphitic carbon black structure remains. This may have the effect of significantly reducing the density of the carbon black, allowing equivalent conductivity with a lower carbon black/polymer ratio.

In certain applications, conductive carbon black may be mixed with carbon nanostructures or carbon nanotubes to form a cable compound with certain desirable properties. Carbon nanostructures and nanotubes are evolving markets. Although the carbon black particles and the carbon nanostructures or nanotubes may remain discrete and separate in the solution, their intermingled presence does provide some advantages. Carbon nanotubes and nanostructures may be required to be suspended in a solution (e.g., a hydrocarbon solution). The size and complexity of carbon nanotubes and/or nanostructures may make dispersion difficult. Methods and compositions are needed to provide for effective dispersion of carbon nanotube and/or carbon nanostructures in a fluid. Existing dispersants may be costly and lack suitable performance.

### DESCRIPTION OF CERTAIN EMBODIMENTS

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the invention.

The present disclosure relates to compositions and methods for the use of dispersants for carbon nanotube or carbon nanostructure dispersions. Particularly, the present disclosure relates to systems and methods for compositions including: a non-aqueous fluid; a carbon nanostructure; a dispersant or combination of dispersants; and a solvent. In certain embodiments, the dispersant of the present disclosure may improve the dispersal of carbon nanotubes and/or carbon nanostructures in a fluid.

Among the many potential advantages to the methods and compositions of the present disclosure, only some of which are alluded to herein, the methods, compositions, and systems of the present disclosure may provide improved dispersal of carbon nanotubes or carbon nanostructures, reduced cost compared to other dispersants, and/or improved quality of the dispersion composition or of products manufactured with the dispersion composition.

In certain embodiments, the compositions and methods of the present disclosure may include one or more carbon nanostructures or carbon nanotubes. As used herein, the term “carbon nanostructures” may include zero-dimensional (“0D”), one-dimensional (“1D”), two-dimensional (“2D”), and three-dimensional (“3D”) structures having nanoscale dimension. As used herein, the term “nanoscale” refers to dimensions of up to 100 nanometers, e.g., 0.1-100 nm. In some embodiments, the carbon nanostructures may be OD materials with all dimensions being nanoscale. For example, in some embodiments, the carbon nanostructures may be carbon dots, nanoparticles, dendrimers, nanocapsules, Fullerenes, nanoclusters, or nanodispersions. In other embodiments, the carbon nanostructures may be 1D materials with two dimensions being nanoscale and the third dimension being greater than nanoscale. For example, in some embodiments, the carbon nanostructures may be nanofibers, nanotubes, nanowires, or nanorods. In other embodiments, the carbon nanostructures may be 2D materials with one dimension (thickness) being nanoscale and other dimensions being greater than nanoscale. For example, in some embodiments, the carbon nanostructures may be graphene or boron nitride nanosheets, thin-films, and nanomembranes. In still other embodiments, the carbon nanostructures may be 3D materials in which nanoscale features (i.e., 0D, 1D, and/or 2D materials) are present but with all dimensions greater than nanoscale.

As described above, the compositions and methods of the present disclosure may include carbon nanostructures that may be carbon nanotubes. Carbon nanotubes are tubular molecules in which one carbon atom is bonded with other carbon atoms in a honeycomb arrangement. In some embodiments, the carbon nanotubes of the present disclosure may have a single wall (single wall carbon nanotubes). Single wall carbon nanotubes may have diameters of about 0.7 to about 3 nanometers. In other embodiments, the carbon nanotubes of the present disclosure may have multiple walls (multi-wall carbon nanotubes). Multi-wall carbon nanotubes may have diameters in a range of from about 3.5 to about 500 nanometers. In some embodiments, the carbon nanotubes of the present disclosure may have aspect ratios in a range of from about 5 to about 10,000. In some embodiments, the carbon nanotubes of the present disclosure may be in the form of ropes. In other embodiments, the carbon nanotubes of the present disclosure may exist in the form of bundles.

The compositions and methods of the present disclosure may also include one or more dispersants. Without intending to be limited to any particular theory or mechanism, it is believed that carbon nanostructures may have large surface attractive forces. Accordingly, it is believed that carbon nanostructure particles easily aggregate with each other. In some embodiments, the dispersant may reduce the affinity for nanostructure particles to aggregate with one another. In certain embodiments, the dispersant may include a head and a tail. In some embodiments, the head may have an affinity for a dispersoid (e.g., the carbon nanostructures), which is the material to be dispersed. In some embodiments, the tail may have an affinity for a dispersion medium, which is a solvent for dispersing materials. In certain embodiments, the dispersant may also serve as a barrier for the collision between particles.

In certain embodiments, the dispersant of the present disclosure may include a nonylphenol resin. In some embodiments, the nonylphenol resin may be a low molecular nonylphenol resin having a molecular weight less than about 3,000 g/mol. In other embodiments, the nonylphenol resin may be a medium molecular weight nonylphenol resin. In some embodiments, the medium molecular weight nonylphenol resin may have a molecular weight in the range of from about 3,000 g/mol to about 15,000 g/mol. In other embodiments, the medium molecular weight nonylphenol resin may have a molecular weight in the range of from about 5,000 g/mol to about 12,000 g/mol. In still other embodiments, the nonylphenol resin may include a high molecular weight nonylphenol resin having a molecular weight of greater than about 15,000 g/mol. In some embodiments, the dispersant may include an ethoxylated nonylphenol resin. In some embodiments, the dispersant may include polyisobutylene succinic anhydride. In some embodiments, the dispersant may include a calcium overbased sulfonate. In some embodiments, the dispersant may include N-methyl-2-pyrrolidone (NMP). In some embodiments, the dispersant may include imidazoline. In certain embodiments, the dispersant may include any derivative or combination of the above. In some embodiments, the dispersant may be present in the compositions of the present disclosure at a concentration sufficient to disperse the carbon nanostructures in the composition. In certain embodiments, dispersant may be present at a concentration in a range of from about 25% to about 300% of the carbon nanostructure concentration by active weight. In other embodiments, dispersant may be present at a concentration in a range of from about 25% to about 200% of the carbon nanostructure concentration by active weight.

The compositions and methods of the present disclosure may include any non-aqueous fluid known in the art. In some embodiments, the non-aqueous fluid may be a hydrocarbon. Aqueous fluids that may be suitable for use in the methods and compositions of the present disclosure may include water from any source. Examples of hydrocarbons that may be included in the fluids of the present disclosure include, but are not limited to, α-olefins, internal olefins, alkanes, aromatic solvents, cycloalkanes, liquefied petroleum gas, kerosene, diesel oils, crude oils, gas oils, fuel oils, paraffin oils, mineral oils, low-toxicity mineral oils, olefins, esters, amides, synthetic oils (e.g., polyolefins), polydiorganosiloxanes, siloxanes, organosiloxanes, ethers, acetals, dialkylcarbonates, and combinations thereof. In some embodiments, the non-aqueous fluids may make up as much as 99% of the fluid.

In some embodiments, the compositions of the present disclosure may include one or more solvents and/or cosolvents. In certain embodiments, solvent or cosolvents may stabilize or improve the ease of use of a carbon nanotube or carbon nanostructure dispersion. In some embodiments, solvents may include organic solvents. For example, solvents suitable for certain embodiments of the present disclosure include, but are not limited to toluene, xylene, methanol, isopropyl alcohol, any alcohol, glycol, N-methyl-2-pyrrolidone (NMP), any organic solvent, and any combination thereof In certain embodiments, the compositions of the present disclosure may include any number of additional additives. A person skilled in the art, with the benefit of this disclosure, will recognize the types of additives that may be included in the fluids of the present disclosure for a particular application. In some embodiments, the solvents may be part of the bulk fluid. In other embodiments, the solvents may be used to stabilize the bulk fluid/dispersant blend. In embodiments where the solvents are used to stabilize the blend, a co-solvent may make up less than 5% of the bulk fluid.

In certain embodiments, the compositions of the present disclosure may further include one or more additives selected from the group consisting of an organic binder, a photosensitive monomer, a photoinitiator, a viscosity modifier, a storage stabilizer, a wetting agent, and an acid or a base within a range in which the material properties of the composition are maintained. In some embodiments, the additive may be present in a range of from about 0.1 to about 60 parts by weight, based on 100 parts by weight of the composition. In some embodiments, the additive may include an organic binder such as celluloses including ethylcellulose, styrenes, a styrene-acrylic acid ester copolymer, polyvinylbutyral, polyvinylalcohol, and polypropylene carbonate, and the like. In some embodiments, the additive may include any common photosensitive monomers and photoinitiators. For example, in certain embodiments, the photosensitive monomer may include a thermally-degradable acrylate monomer, a benzophenone monomer, an acetophenone monomer, a thiokisantone monomer, and the like. In some embodiments, the additive may include any common viscosity modifiers and storage stabilizers. For example, in certain embodiments, the viscosity modifier may include casein, carboxymethyl cellulose, and the like. In some embodiments, the additive may include any common wetting agents. For example, in certain embodiments, polyvalent alcohols, including glycerin, ethylene glycol, diethylene glycol, triethylene glycol, propylene glycol, dipropylene glycol, 1,3-butanediol, 1,4-butanediol, 1,5-pentanediol, 1,2-hexanediol, 2-methyl-2-pentanediol and the like, may be used as the wetting agent. In some embodiments, the additive may include an acid or a base. An acid or base may increase the solubility of a dispersant in the solvent, and serves to stabilize the dispersion of the carbon nanostructures by imparting an electrostatic repulsive force to the dispersed carbon nanostructure particles. In some embodiments, hydrochloric acid, sulfuric acid, nitric acid, acetic acid, carbonic acid, and the like, may be used as the acid. In some embodiments, sodium hydroxide, potassium hydroxide, calcium hydroxide, ammonium hydroxide, and the like, may be used as the base.

In certain embodiments, the methods of the present disclosure may include forming a fluid that includes a non-aqueous fluid; a carbon nanostructures; a dispersant or combination of dispersants, and a solvent. In some embodiments, the compositions are formed by first adding the dispersant to the solvent. The non-aqueous fluid may then be added to the solvent and dispersant. Finally, the carbon nanostructures may then be added to the solvent, dispersant, and/or non-aqueous fluid.

In certain embodiments, the present disclosure relates to compositions and methods useful in processes including, but not limited to electronics manufacturing, paints, pigments, manufacturing electronic components, solar panel (photovoltaics) components, conductor substrates, or for paint-on conductors and similar applications. A person skilled in the art with the benefit of this disclosure will recognize other applications in which the methods and compositions of the present disclosure could be used. In certain embodiments, the methods and compositions of the present disclosure may use any equipment known in the art. In some embodiments, these compositions/methods could be used to manufacture components that could be used in oilfield and/or refining applications.

An embodiment of the present disclosure is a composition including a non-aqueous fluid; a carbon nanostructure; a dispersant selected from the group consisting of: a high molecular weight nonylphenol resin, a medium molecular weight nonylphenol resin, a low molecular weight nonylphenol resin, an ethoxylated nonylphenol resins, any derivative of the foregoing, and any combination thereof and a solvent.

In one or more embodiments described in the preceding paragraph, the carbon nanostructure is selected from the group consisting of: a one-dimensional material, a two-dimensional material, a three dimensional material, and any combination thereof. In one or more embodiments described above, the carbon nanostructure further includes one or more carbon nanotubes. In one or more embodiments described above, the dispersant is high molecular weight nonyphenol resin having a molecular weight greater than about 15,000 g/mol. In one or more embodiments described above, the dispersant is medium molecular weight nonyphenol resin having a molecular weight in a range of from about 3,000 g/mol to about 15,000 g/mol. In one or more embodiments described above, the dispersant is low molecular weight nonyphenol resin comprises a molecular weight less than about 3,000 g/mol. In one or more embodiments described above, the non-aqueous fluid further includes a hydrocarbon. In one or more embodiments described above, the hydrocarbon further includes xylene. In one or more embodiments described above, the composition further includes an additional dispersant selected from the group consistent of: a polyisobutylene succinic anhydride, a calcium overbased sulfonate, N-methyl-2-pyrrolidone (NMP), imidazoline, any derivative of the foregoing, and any combination thereof. In one or more embodiments described above, the dispersant is present at a concentration in a range of from about 25% to about 300% of the carbon nanostructure concentration by active weight.

Another embodiment of the present disclosure is a method including providing a solvent; adding a dispersant to the solvent, wherein the dispersant is selected from the group consisting of: a high molecular weight nonylphenol resin, a medium molecular weight nonylphenol resin, a low molecular weight nonylphenol resin, an ethoxylated nonylphenol resins, polyisobutylene succinic anhydride, a calcium overbased sulfonate, imidazoline, any derivative of the foregoing, and any combination thereof adding a non-aqueous fluid to the solvent and the dispersant; and adding a carbon nanostructure to the solvent, the dispersant, and the non-aqueous fluid.

In one or more embodiments described in the preceding paragraph, the carbon nanostructure is selected from the group consisting of: a one-dimensional material, a two-dimensional material, a three dimensional material, and any combination thereof. In one or more embodiments described above, the carbon nanostructure further includes one or more carbon nanotubes. In one or more embodiments described above, the dispersant is a high molecular weight nonyphenol resin having a molecular weight greater than about 15,000 g/mol. In one or more embodiments described above, the dispersant is a medium molecular weight nonyphenol resin having a molecular weight in a range of from about 3,000 g/mol to about 15,000 g/mol. In one or more embodiments described above, the dispersant is a low molecular weight nonyphenol resin having a molecular weight less than about 3,000 g/mol. In one or more embodiments described above, the non-aqueous fluid further includes a hydrocarbon. In one or more embodiments described above, the dispersant is present at a concentration in a range of from about 25% to about 300% of the carbon nanostructure concentration by active weight.

Another embodiment of the present disclosure is a method including providing a solvent; adding a dispersant to the solvent, wherein the dispersant is selected from the group consisting of: a high molecular weight nonylphenol resin having a molecular weight greater than about 15,000 g/mol, a medium molecular weight nonylphenol resin having a molecular weight in a range of from about 3,000 g/mol to about 15,000 g/mol, a low molecular weight nonylphenol resin having a molecular weight less than about 3,000 g/mol, any derivative of the foregoing, and any combination thereof adding a non-aqueous fluid that includes xylene to the solvent and the dispersant; andadding one or more carbon nanotubes to the solvent, the dispersant, and the non-aqueous fluid.

In one or more embodiments described in the preceding paragraph, the dispersant is present at a concentration in a range of from about 25% to about 300% of the carbon nanotube concentration by active weight.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The disclosure illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A composition comprising:
a non-aqueous fluid;
a carbon nanostructure;
a dispersant selected from the group consisting of: a high molecular weight nonylphenol resin, a medium molecular weight nonylphenol resin, a low molecular weight nonylphenol resin, an ethoxylated nonylphenol resins, any derivative of the foregoing, and any combination thereof; and
a solvent.

2. The composition of claim 1, wherein the carbon nanostructure is selected from the group consisting of: a one-dimensional material, a two-dimensional material, a three dimensional material, and any combination thereof.

3. The composition of claim 1, wherein the carbon nanostructure further comprises one or more carbon nanotubes.

4. The composition of claim 1, wherein the dispersant is high molecular weight nonyphenol resin having a molecular weight greater than about 15,000 g/mol.

5. The composition of claim 1, wherein the dispersant is medium molecular weight nonyphenol resin having a molecular weight in a range of from about 3,000 g/mol to about 15,000 g/mol.

6. The composition of claim 1, wherein the dispersant is low molecular weight nonyphenol resin comprises a molecular weight less than about 3,000 g/mol.

7. The composition of claim 1, wherein the non-aqueous fluid further comprises a hydrocarbon.

8. The composition of claim 7, wherein the hydrocarbon further comprises xylene.

9. The composition of claim 1, wherein the composition further comprises an additional dispersant selected from the group consistent of: a polyisobutylene succinic anhydride, a calcium overbased sulfonate, N-methyl-2-pyrrolidone (NMP), imidazoline, any derivative of the foregoing, and any combination thereof.

10. The composition of claim 1, wherein the dispersant is present at a concentration in a range of from about 25% to about 300% of the carbon nanostructure concentration by active weight.

11. A method of forming a fluid comprising:
providing a solvent;
adding a dispersant to the solvent, wherein the dispersant is selected from the group consisting of: a high molecular weight nonylphenol resin, a medium molecular weight nonylphenol resin, a low molecular weight nonylphenol resin, an ethoxylated nonylphenol resins, polyisobutylene succinic anhydride, a calcium overbased sulfonate, imidazoline, any derivative of the foregoing, and any combination thereof;
adding a non-aqueous fluid to the solvent and the dispersant; and
adding a carbon nanostructure to the solvent, the dispersant, and the non-aqueous fluid.

12. The method of claim 11, wherein the carbon nanostructure is selected from the group consisting of: a one-dimensional material, a two-dimensional material, a three dimensional material, and any combination thereof.

13. The method of claim 11, wherein the carbon nanostructure further comprises one or more carbon nanotubes.

14. The method of claim 11, wherein the dispersant is a high molecular weight nonyphenol resin having a molecular weight greater than about 15,000 g/mol.

15. The method of claim 11, wherein the dispersant is a medium molecular weight nonyphenol resin having a molecular weight in a range of from about 3,000 g/mol to about 15,000 g/mol.

16. The method of claim 11, wherein the dispersant is a low molecular weight nonyphenol resin having a molecular weight less than about 3,000 g/mol.

17. The method of claim 11, wherein the non-aqueous fluid further comprises a hydrocarbon.

18. The method of claim 11, wherein the dispersant is present at a concentration in a range of from about 25% to about 300% of the carbon nanostructure concentration by active weight.

19. A method of forming a fluid comprising:
providing a solvent;
adding a dispersant to the solvent, wherein the dispersant is selected from the group consisting of: a high molecular weight nonylphenol resin having a molecular weight greater than about 15,000 g/mol, a medium molecular weight nonylphenol resin having a molecular weight in a range of from about 3,000 g/mol to about 15,000 g/mol, a low molecular weight nonylphenol resin having a molecular weight less than about 3,000 g/mol, any derivative of the foregoing, and any combination thereof;
adding a non-aqueous fluid that comprises xylene to the solvent and the dispersant; and
adding one or more carbon nanotubes to the solvent, the dispersant, and the non-aqueous fluid.

20. The method of claim 19, wherein the dispersant is present at a concentration in a range of from about 25% to about 300% of the carbon nanotube concentration by active weight.
